(19) United States
(12) Patent Application Publication
(10) Pub. No.: US 2007/0166518 A1
(43) Pub. Date: Jul. 19, 2007

(54) Security element comprising a partial magnetic layer

(76) Inventor: Ludwig Brehm, Adelsdorf (DE)

Correspondence Address: Hoffmann & Baron, 6900 Jericho Turnpike, Syosset, NY, 11791, US

(21) Appl. No.: 10/587,710

(22) PCT Filed: Jan. 26, 2005
(86) PCT No.: PCT/DE05/00103

§ 371 Date: Jul. 28, 2006

(30) Foreign Application Priority Data
Jan. 30, 2004 (DE) 10 2004 004 713.8

(51) Int. Cl. B41M 5/00

(52) U.S. Cl. 428/195.1

(57) ABSTRACT

The invention concerns a security element, in particular a security thread, for value documents such as banknotes, credit cards, identity passes or tickets, which has at least one partial magnetic layer for storing an item of coded information, and a process for the production thereof. An adhesive layer 11s of a radiation-crosslinkable adhesive is applied to a first film body 51, the adhesive layer 11s of the radiation-crosslinkable adhesive is applied in a form structured in pattern form to the base film 51 and/or is irradiated in pattern form in such a way that the adhesive layer hardens structured in pattern form. A transfer film 41 which has a carrier film and a magnetic layer is applied to the adhesive layer 11s with an orientation of the magnetic layer relative to the adhesive layer and the carrier film is removed from the second film body including the first film body 51, the adhesive layer 11s and the magnetic layer. The magnetic layer remains on the first film body 51 in a first region structured in pattern form and the magnetic layer remains on the carrier film in a second region structured in pattern form and is removed with the carrier film from the first film body 51.

The invention concerns a security element, in particular a security thread for value documents such as banknotes, credit cards, identity cards or passes or tickets, which has at least one partial magnetic layer for storing an item of coded information, and a process for the production thereof.

Magnetic layers for storing items of information can be of a soft-magnetic, hard-magnetic or paramagnetic configuration. In order to obtain a high level of data security it is necessary to implement structuring of the magnetic layer with a high level of resolution and register accuracy.

The magnetic layer can be provided with magnetic particles, preferably iron oxide pigments, as described in German patent specification No 697 02 321 T2, or in the form of amorphous metal glass, as described in U.S. Pat. No. 4,960,651.

German patent specification No 695 05 539 T2 proposes depositing a magnetic metal on a pretreated elastic substrate from a solution, wherein cobalt with or without nickel, iron and/or phosphorus are provided as the magnetic metal.

Frequently films of that kind are provided with metallic layers for producing reflective optical security elements, for example interference layer systems or diffraction gratings. Iron oxide pigments however, on layers provided with aluminium, lead to corrosion of the aluminium. Presumably that corrosion damage is to be attributed to the fact that the iron oxide pigments act as proton donors, while the fact that the iron oxide pigments have pH-values in a range of between 3.0 and 5.5 also plays a part. Therefore for example DE 42 12 290 C1 proposes that the metal layer is formed by chromium, copper, silver or gold or alloys of at least two of those metals and/or a barrier for preventing the magnetizable particles from having an effect on the metal layer is arranged between the metal layer and the magnetic layer.

Now, the object of the invention is to improve the production of security elements of the stated kind and to provide for the structure of improved security elements.

That object is attained by a process for the production of a security element with a partial magnetic coating in which an adhesive layer of a radiation-crosslinkable adhesive is applied to a first film body, the adhesive layer of the radiation-crosslinkable adhesive is applied in a form structured in pattern form to the first film body and/or is irradiated in pattern form in such a way that the adhesive layer hardens structured in pattern form, a transfer film which has a carrier film and a magnetic layer is applied to the adhesive layer with an orientation of the magnetic layer relative to the adhesive layer and the carrier film is removed from a second film body comprising the first film body, the adhesive layer and the magnetic layer so that the magnetic layer remains on the first film body in a first region structured in pattern form and the magnetic layer remains on the carrier film in a second region structured in pattern form and is removed with the carrier film from the first film body. That object is further attained by a security element produced in accordance with that process, in particular a security thread, which has an adhesive layer comprising a radiation-crosslinkable adhesive which is arranged between a magnetic layer structured in pattern form and a first film body of the security element and connects the magnetic layer structured in pattern form to the first film body.

It is possible by means of the invention for the magnetic layer to be applied to the security element in a continuous process. By virtue of using a transfer film, that is to say by departing from the previous printing processes for applying a partial magnetic layer, it is now possible with the novel production process to introduce magnetic layers into security threads which could not be implemented in that way. It is no longer necessary to use the magnetic layer from a magnetic, generally acid dispersion with optimum printing properties, for example to achieve the required resolution and thickness of the structure to be printed of the magnetic layer. Rather it is possible to introduce magnetic layers which are produced with a production process which would damage or destroy the first film body. In addition the adhesive layer further acts as a functional encapsulation layer and accordingly has a dual function, which leads to further synergies.

Accordingly the invention affords a large number of possible options of introducing magnetic layers with optimised properties, for example a substantially increased magnetic field strength combined with a thinner layer thickness, the use of magnetic layers which do not have any corrosive properties, or magnetic layers which have optical properties of a different kind, into security threads in an inexpensive fashion and with a high level of resolution.

Preferably the invention is used to apply magnetic detectable regions of different sizes, for example line widths in the range of between 0.3 mm and 10 mm, in register relationship with diffractive regions metallised with aluminium pieces. The invention makes it possible in that respect to use for the magnetic layer materials in respect of which no corrosion occurs between the magnetic layer and the aluminium.

Further advantages are afforded in the production of partial magnetic layer regions of a thin line thickness which nonetheless have the required magnetic properties, which allows those regions to be detected. Such thin detectable line thicknesses, for example line thicknesses in the region of 0.3 mm, cannot be achieved with a normal printing process (intaglio printing, flexoprinting, casting) as the required volume of lacquer can only be applied with corresponding deep printing forms which in that case have a tendency to smear. Preferably in that respect the magnetic layer can be of the structure as described hereinafter:

The magnetic layer can be made from magnetic particles. That means that it is possible for example for the density in relation to surface area of the magnetic particles to be increased for example by the particles being sputtered onto the transfer film.

A magnetic layer of such a structure has a magnetic field strength which, with the same layer thickness, is higher approximately by a factor of 100 than a comparable layer comprising a magnetic dispersion.

It can also be provided that the magnetic layer is sputtered and is produced for example in the form of an alloy of iron, cobalt, nickel, molybdenum and further elements, in which respect it can be provided that not all the stated elements are a constituent part of the alloy.

It can now also be provided that the magnetic layer is in the form of magnetic glass. Alloys of that kind are described for example in EP 0 953 937 A1. It is preferably provided that the magnetic layer is made from magnetic glass or amorphous metal glass.

For that purpose it can be provided that amorphous metal glass, that is to say an amorphous, that is to say non-crystalline layer of cobalt and/or iron and/or chromium and/or nickel and/or silicon and/or boron is applied by sputtering or another suitable process to the carrier film. In that respect it is possible to adjust the properties of the magnetic layer by the selection and/or mixing ratio of the specified components.

In addition it is also possible for the metal layer to comprise a dispersion of a magnetic pigment (Fe oxide, Fe oxide doped) in an organic binding agent matrix.

The magnetic layer applied with the process according to the invention induces a markedly higher output signal in a magnetic reading head, typically a signal which is higher by one to two orders of magnitude than magnetic layers applied by printing in accordance with the state of the art. The particular optical properties of those layers and the high quality of the magnetic layer introduced into security threads by means of the process according to the invention are to be emphasised as further advantages.

It is further possible for the magnetic particles to be in the form of nanoparticles.

It is also advantageous that the magnetic layer can be inexpensively produced in the form of a semi-manufactured product, whereby the proportionate production costs per security element are markedly reduced. The production procedure for the transfer film according to the invention has to be optimised only once and does not require any steps for structuring of the magnetic layer such as for example complicated and expensive etching processes.

No particular precautions such as for example alignment marks or the like have to be implemented for positioning the transfer film on the first film body because each portion of the transfer film according to the invention is the same.

The fact that the adhesive is in the form of a radiation-crosslinkable adhesive, preferably an UV-crosslinkable adhesive, means that the security element is not subjected to any thermal stress in the production process according to the invention. As a result no unwanted crystal formation occurs in the formation of the magnetic layer in the form of metal glass, that is to say the metal glass is not structurally altered by the process according to the invention.

It can be provided that the adhesive is electrically insulating. That prevents corrosion damage due to local element formation at the metallic coating, which is observed in particular when the magnetic layer is formed from iron oxide pigments and the metallic coating is formed from aluminium. The iron oxide pigments of the magnetic layer act as proton donors and/or the magnetic layer has pH-values in a range of between 3.0 and 5.5. The fact that the adhesive can be electrically insulating means that corrosion of the metallic coating of aluminium or another metal which is arranged below iron in the electrochemical potential series is prevented. Therefore no local element can be formed between magnetic particle and metallic layer, that is to say reduction of the magnetic particles and oxidation of the metal layer is prevented. The durability of the magnetic layer is not adversely affected in that way. It is however also possible to provide that the adhesive is conductive, for example it can be in the form of an organic conductor and in that way it is possible to render inoperative a local element between magnetic particle and metallic layer by an electrical short-circuit.

The adhesive layer can be applied to the first film body by means of inexpensive printing procedures which can be used on a large industrial scale such as intaglio printing, offset printing and flexoprinting. It is advantageous here that higher levels of resolution can be achieved, with costs that fall at the same time, than in the direct application of the magnetic layer. The flow characteristics of the adhesive can be optimised without reductions in quality in respect of the security element, which is not possible when using a printing ink mixed with magnetic particles.

Therefore structured magnetic layers can be produced in a very high level of resolution on the first film body with the process according to the invention.

The partial magnetic layer produced with the process according to the invention can be of a soft-magnetic, hard-magnetic or paramagnetic configuration. In that situation it is possible to adjust in particular the coercive force of the magnetic layer, which is crucial for the selected reading process.

The possible use of the process according to the invention in the context of a large-industrial roll-to-roll process is of further advantage. In that case further processes can be provided before and/or after the process according to the invention. For example the application of a metallic layer to the first film body can be provided, prior to the process according to the invention.

The security element according to the invention is distinguished by a high level of reading reliability, good adaptability to different reading processes, long service life and low production costs.

It can be provided that a machine-readable code is stored as a magnetic code in the magnetic layer of the security element. In that case for example when a magnetic reading head is moved past the layer a signal is generated in the magnetic reading head, which can be an item of information in the form of a security code. In that respect it is of particular advantage that the applicability of the security element according to the invention is not limited to a reading principle. Rather, the property of the magnetic layer of the security element can be adapted to the magnetic reading principle so that the applicability of the security element produced with the process according to the invention is not restricted to one type of reading unit.

Further advantageous configurations of the invention are set forth in the appendant claims.

In accordance with a first preferred embodiment of the invention it is provided that the adhesive layer comprising a radiation-crosslinkable adhesive is applied structured in pattern form to the first film body by means of a printing process, the transfer film is applied to the adhesive layer structured in pattern form, the adhesive layer is hardened by irradiation, and the carrier film is then removed from the second film body comprising the first film body, the adhesive layer and the magnetic layer, so that the magnetic layer remains on the first film body in the first region coated in pattern form with the radiation-crosslinkable adhesive and is removed in the remaining second region with the carrier film.

Advantageously the periphery of the printing cylinder is such that it corresponds to the length of a security element. It is also possible however to provide that the periphery of the printing cylinder corresponds to n-times the length of the security element, wherein n denotes an integer of greater than 1.

It is however also possible to provide that the adhesive layer is applied to the first film body in the form of a homogenous layer, in which case it is possible to provide a process as an alternative to the printing process, for example spraying with an adhesive solution and subsequent drying. The adhesive layer comprising a radiation-crosslinkable adhesive is then irradiated in pattern form after application of the transfer film, whereby the adhesive layer hardens in a region which is structured in pattern form.

In that case, it is possible to provide a mask for exposure of the adhesive in pattern form, with the mask being arranged between the radiation source and the film body. The radiation source can be arranged in such a way that it exposes the film body from the side of the transfer film or from the side of the first film body.

It is advantageously provided that the mask is in the form of a circulating mask. That permits a continuous production procedure, for example a roll-to-roll process. In that case the peripheral speed of the mask can be such that the relative speed between the security element and the mask is equal to zero. It can be provided that the mask is in the form of a mask roller around which the film body at least partially extends. It is also possible however to provide that the mask is in the form of an endless mask belt which circulates at the transport speed of the film body, wherein the film body and the mask belt are arranged in directly adjacent relationship at least in an exposure portion. That avoids parallax between the mask and the film body. Advantageously the radiation source, for example an UV lamp, is in the form of a collimator, that is to say in the form of a radiation source with a parallel exit beam path.

Advantageously the periphery of the mask roller or the mask belt is such that it corresponds to the length of a prepared security element. It is also possible to provide however that the periphery of the mask roller or the mask belt corresponds to n-times the length of the prepared security element, wherein n denotes an integer of greater than 1.

Thereafter the carrier film is pulled off from the second film body comprising the first film body, the adhesive layer and the magnetic layer, as described hereinbefore.

In that respect it is possible for the adhesive layer to be exposed in pattern form prior to application of the transfer film so that the adhesive layer hardens in a region structured in pattern form. The carrier film is then pulled off the film body formed from the base film and the magnetic layer. In the region in which the adhesive layer has not hardened, the magnetic layer is fixed by the adhesive layer and remains on the base body. In the remaining region in which the adhesive layer has hardened the magnetic layer remains on the transfer film and is removed with the carrier film.

It is also possible for the adhesive layer to be exposed in pattern form after application of the transfer film so that the adhesive layer hardens in a region which is structured in pattern form. The carrier film is then removed from the film body formed from the base film and the magnetic layer. In the region in which the adhesive layer has hardened structured in pattern form, the magnetic layer is fixed by the adhesive layer and remains on the base body. In the remaining region in which the adhesive layer has not hardened the magnetic layer remains on the transfer film and is pulled off with the carrier film. In that situation it is necessary to use a radiation-crosslinkable adhesive which in the non-hardened state has a lower adhesion force in relation to the magnetic layer than the adhesive force between the magnetic layer and the carrier film.

It can be provided that the film body is irradiated once again after the carrier film has been pulled off in order to harden all adhesive regions.

In order to ensure adequate exposure of the adhesive layer in the above-described processes, it is advantageous to form the magnetic layer from a semi-transparent material, for example from the above-described magnetic glass layer, and to use a radiation-transmissive carrier film. That makes it possible for the adhesive layer to be irradiated from the side of the transfer film through the transfer film. Alternatively there is the possibility of the first film body being of a radiation-transparent configuration and for the adhesive layer to be exposed from the side of the first film body through the film body.

The magnetic layer can be applied directly to a carrier film. It can also be provided however that a release layer is arranged between the magnetic layer and the carrier film. The release layer can be made for example from 99.5 parts of toluene and 0.5 parts of ester wax (dropping point 90° C.) and applied to the carrier film preferably in a thickness of between 0.01 and 0.2 μm.

The security element according to the invention is distinguished by being of a particularly simple structure. Because the partial magnetic layer of the security element is positioned by the adhesive the degree of accuracy of positioning and the geometrical configuration of the portions of the magnetic layer are determined essentially only by the precision of the printing process or the exposure process. Both printing processes and also exposure processes can be provided as a continuous roll-to-roll manufacturing procedure.

In another advantageous embodiment of the security element it can be provided that the magnetic code is arranged a plurality of times on the longitudinal axis of the security element. In that way the signal delivered by the magnetic reading head is redundant for the magnetic code is provided a plurality of times on the longitudinal extent of the prepared security element. In that way errors can be easily eliminated.

The invention is described by way of example hereinafter by means of a number of embodiments with reference to the accompanying drawings in which:

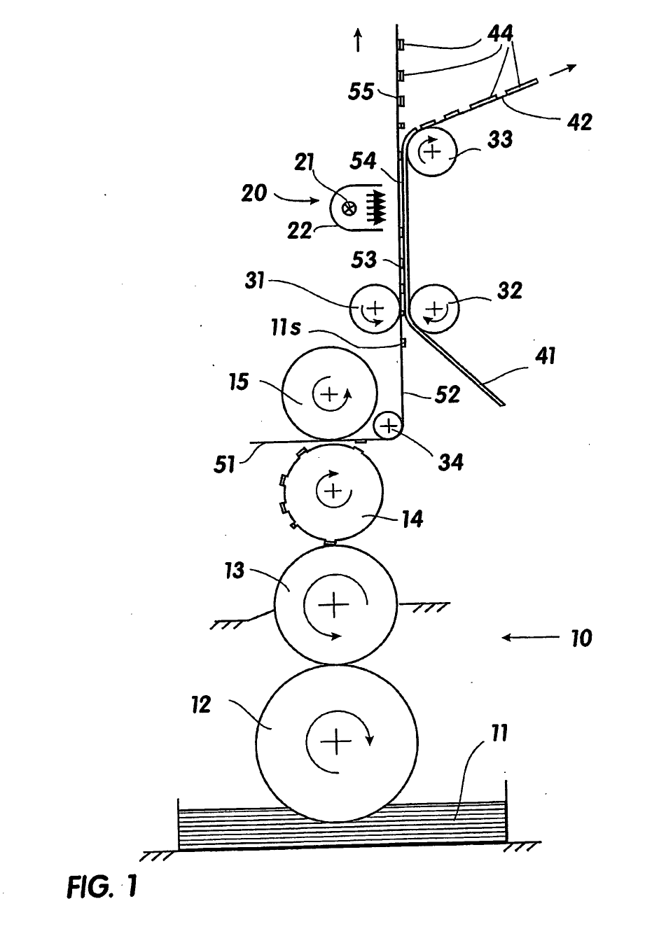

FIG. 1 is a functional view of implementation of a process in accordance with a first embodiment of the invention,

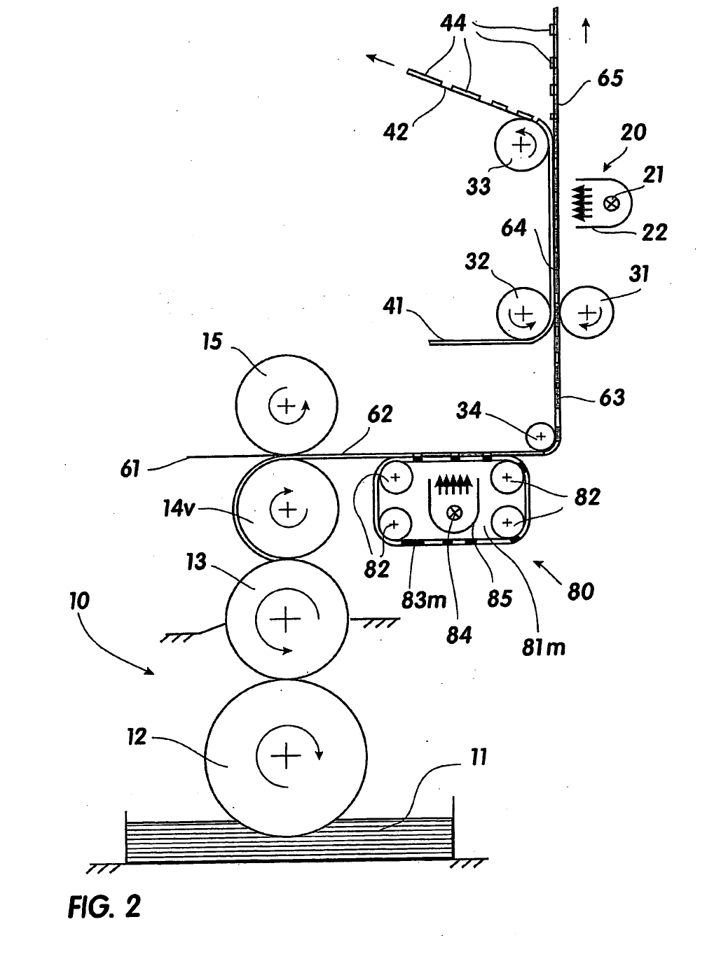

FIG. 2 is a functional view of implementation of a process in accordance with a second embodiment of the invention,

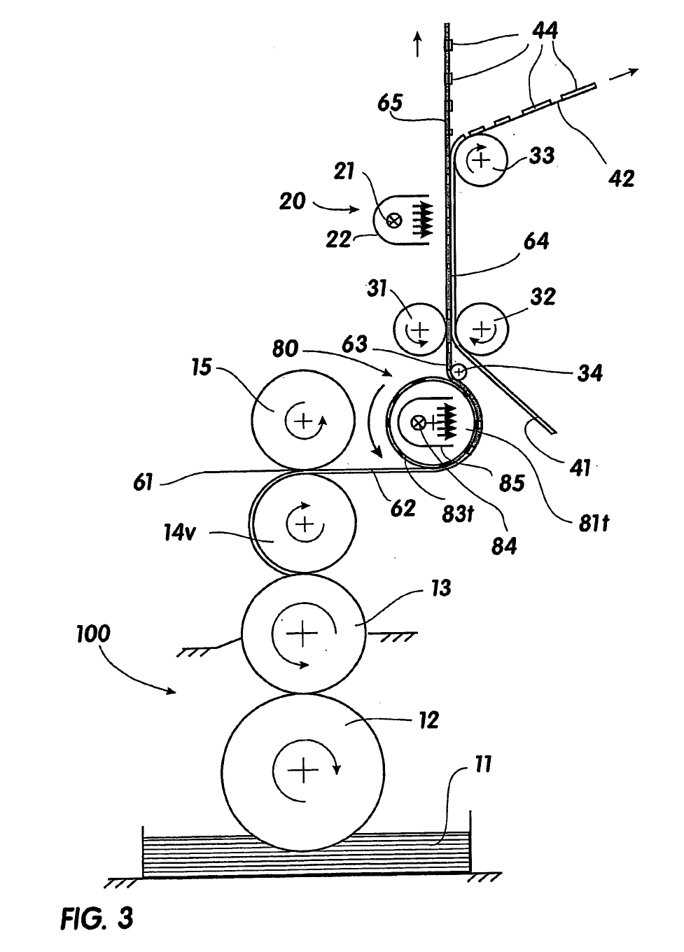

FIG. 3 is a functional view of implementation of a process in accordance with a third embodiment of the invention,

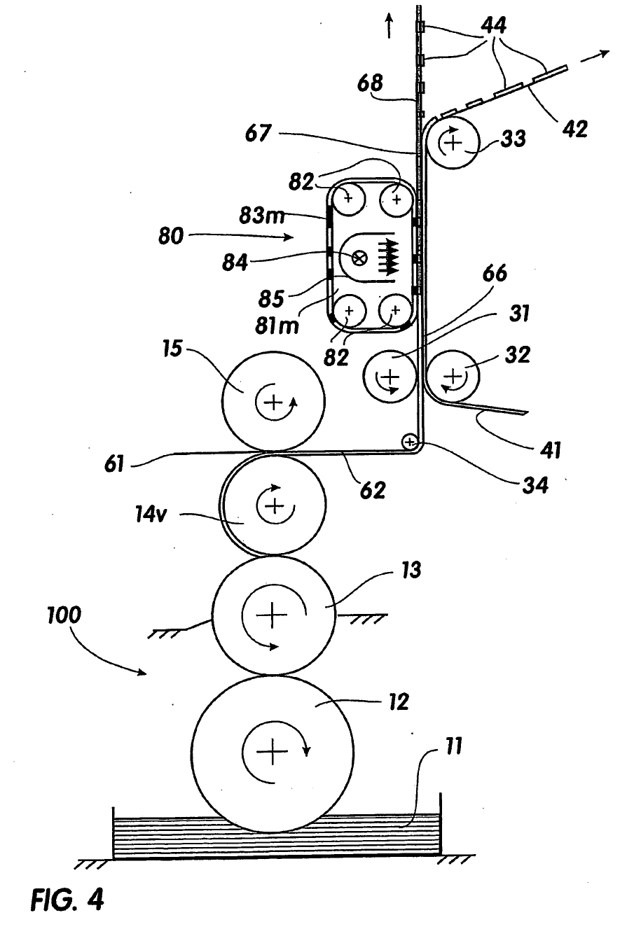

FIG. 4 is a functional view of implementation of a process in accordance with a fourth embodiment of the invention,

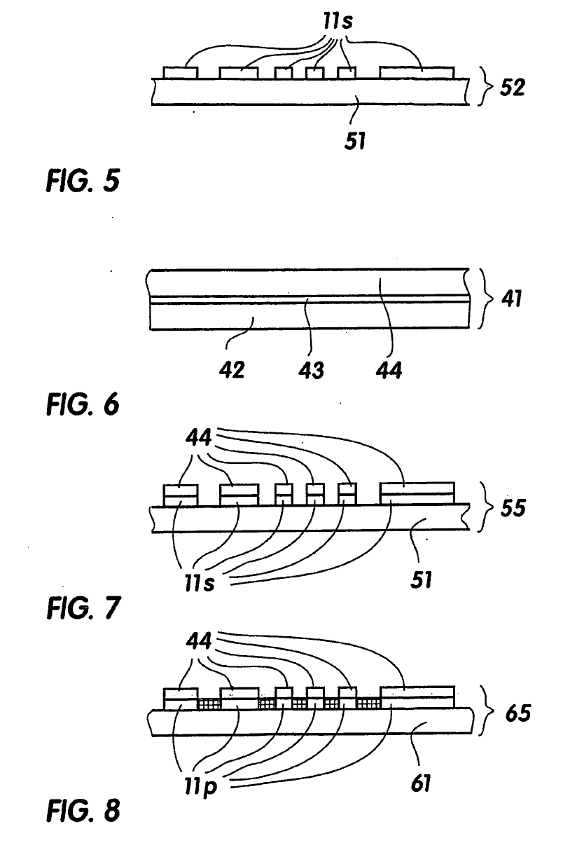

FIG. 5 shows the layer structure of a base film coated with adhesive for the process shown in FIG. 1,

FIG. 6 shows the layer structure of a transfer film for the process shown in FIG. 1, FIG. 2 or FIG. 3,

FIG. 7 shows the layer structure of a film produced in accordance with the process of FIG. 1, and

FIG. 8 shows the layer structure of a film produced in accordance with the process of FIG. 2 or FIG. 3.

FIG. 1 diagrammatically shows a portion of a roll-to-roll manufacturing procedure by means of which a film with security elements with partial magnetic layers is produced.

FIG. 1 shows a printing station 10, an exposure station 20, three rollers 31, 32 and 33 and a deflection roller 34. A film body 51 is fed to the printing station 10. The film body 51 which is processed by the printing station 10 is fed in the form of a film 52 by way of the deflection roller 34 to the pair of rollers 31 and 32 which apply to the film 52 a transfer film 41 which has been unrolled from a supply roll (not shown in FIG. 1). That affords the film 53. The film 53 which has been processed by the exposure station 20 is fed in the form of the film 54 to the roller 33 where a carrier film 53 is pulled off the film 54 and a film 55 remains as a residual film.

In the simplest case the film body 51 can be a carrier film. Such a carrier film preferably comprises a plastic film of a thickness of between 6 and 200 μm, for example a polyester film of a thickness of between 19 and 38 μm. Usually however besides such a carrier film the film body 51 will also have further layers which are applied in preceding process operations. Layers of that kind are for example lacquer layers and metallic layers. In that respect it is also possible for those layers to be already present in structured form in the film body 51. The film 51 is fed to the printing station 10 preferably in register relationship so that the flexoform in the printing mechanism applies the adhesive by printing only at the predetermined locations. If the carrier film has for example a partially shaped metal layer (for example a barcode), the adhesive is applied by printing in register relationship with respect to the metallised regions.

For that purpose the printing station 10 has an insetting device which by way of a reading head registers markings on the carrier film and controls the motor of the printing cylinder 14 in such a way that printing of the adhesive occurs in register relationship.

The printing station 10 has an ink tank with an UV-crosslinkable adhesive 11. The adhesive 11 is applied to a printing cylinder 14 by means of a plurality of transfer rollers 12 and 13.

The printing cylinder 14 now prints the film body 51 which passes through between the printing cylinder 14 and an impression roller 15, structured in pattern form, with an adhesive layer 11s of the UV-crosslinkable adhesive 11.

The printing station 10 is preferably an offset printing or flexoprinting station. It is however also possible for the printing station 10 to be an intaglio printing station.

The adhesive layer 11s is preferably of a thickness of between 0.5 and 10 μm.

The following adhesives can preferably be used as the UV-crosslinkable adhesive 11:

Foilbond UHV 0002 from AKZO NOBEL INKS and UVAFLEX UV Adhesive VL000ZA from Zeller+Gmelin GmbH.

Preferably the adhesives are applied to the film body 51, with an application weight of between 1 and 5 g/m².

The printing operation thus affords an adhesive-coated film 52 in which an adhesive layer 11s structured in pattern form is applied to the film body 51 (see FIG. 5).

Depending on the respective nature of the adhesive 11 used it is also possible in that respect for the adhesive-coated film 52 to pass through a drying passage in which the adhesive layer 11s is dried for example at a temperature of between 100 and 120° C.

FIG. 6 shows the structure of the transfer film 41. The transfer film 41 has a carrier film 42, a release layer 43 and a magnetic layer 44.

The carrier film 42 is a plastic film of a thickness of between 4 and 75 μm. Preferably the carrier film 42 is a film of polyester, polyethylene, an acrylate or a foamed composite material. The thickness of the carrier film 42 is preferably 12 μm.

The release layer 43 preferably comprises a type of wax. The release layer 43 can be made for example from 99.5 parts of toluene and 0.5 parts of ester wax (dropping point 90° C.).

It is also possible to dispense with the release layer 43 if the materials of the carrier film 41 and the magnetic layer 44 are so selected that the adhesion forces between the magnetic layer 44 and the carrier film 43 do not impede reliable and rapid release of the magnetic layer 44. Preferably the release layer 43 is applied to the carrier film 42 in a thickness of between 0.01 and 0.2 μm.

The magnetic layer 44 is preferably in the form of a transfer layer comprising a release layer, a dispersion of a magnetic pigment and a bonding agent layer which provides for a bond between the magnetic dispersion and the UV-crosslinkable adhesive. The magnetic pigment used for the dispersion can be of low or high coercivity. The known processes, for example a printing process, can serve for applying the magnetic dispersion to the release layer.

The magnetic layer 44 however can also be in the form of a layer of amorphous metal glass, that is to say an alloy of preferably cobalt and/or iron and/or chromium and/or nickel and/or silicon and/or boron in an amorphous structure. Sputtering is in particular suitable as the coating process for applying such layers to the carrier film 42 and the release layer 43 respectively.

The magnetic layer 44 can be of soft-magnetic, hard-magnetic or paramagnetic nature in dependence on its composition so that it can be compatible with different reading processes of the magnetic reading units.

The exposure station 20 shown in FIG. 1 has an UV lamp 21 and a reflector 22 which focuses the UV radiation emitted by the UV lamp 21 onto the film 53. In that case the power of the UV lamp 21 is so selected that, as it passes through the exposure station 20, the adhesive layer 11s is irradiated with a sufficient amount of energy which ensures reliable hardening of the adhesive layer 11k. As shown in FIG. 1 in that situation the film 53 is irradiated from the side of the film body 51. That is possible if the film body 51 is UV-transparent. If the magnetic layer 44 is in the form of a transparent or semi-transparent layer, for example as stated above in the form of magnetic glass, the film 53 can also be irradiated from the side of the carrier film 42. It will be noted however that it is further necessary for that purpose for the carrier film 42 and the release layer 43 to comprise an UV-transparent material.

Due to the hardening of the adhesive layer 11s which is structured in pattern form, the magnetic layer 44 is caused to adhere to the film body 51 at the locations at which the adhesive layer 11s is provided. If then subsequently the carrier film 42 is pulled off the remaining film body of the film 54 the magnetic layer 42 adheres to the film body 51 in the regions in which the adhesive layer 11s is applied by printing and thus released from the transfer film 41 at those locations. At the other locations the adhesion between the magnetic layer 44 and the release layer 43 predominates so that here the magnetic layer 44 remains in the transfer film 41.

FIG. 7 now shows the film 55, that is to say the resulting film body after removal of the carrier film 42. FIG. 7 shows the film body 51, the adhesive layer 11s and the magnetic layer 44. As shown in FIG. 7 the film 55 now has a magnetic layer 44 which is structured in pattern form and which is arranged on the film body 51 in accordance with the adhesive layer 11s which is structured in pattern form.

In addition it is also possible for the film 55, besides the partially applied magnetic layer 44, also to have further layers which implement security features. Preferably in that respect the film 44 has diffractive, partially metallised regions which, in the viewing direction, are arranged above the magnetic regions of the magnetic layer 44 in the film 55. The magnetically detectable regions in that case are preferably arranged in register relationship with the diffractive regions of the film 44, which are preferably partially metallised with aluminium. Furthermore it is possible, in addition to or instead of such diffractive partially metallised regions, to provide colour change elements, for example comprising thin film elements or thin film pigments, or UV- or IR-fluorescing elements in the film 44 and to arrange them in register relationship with the magnetically detectable regions.

A further embodiment of the invention will now be described with reference to FIG. 2.

FIG. 2 shows the printing station 10, an exposure station 80, the exposure station 20, the deflection roller 34, the pair of rollers 31 and 32 and the release roller 33.

The printing station 100 is constructed like the printing station 10 shown in FIG. 1, with the difference that the printing cylinder 14 is replaced by a printing cylinder 14v which applies the adhesive 11 by printing to a supplied film body 61, over the full area involved. Preferably a prepolymer UV-crosslinkable adhesive is used in that case.

In that respect it is also possible for the adhesive layer to be applied to the film body 61 not by a printing process but by another coating process, for example painting on, pouring or spraying. In addition it is also possible for the printing of the adhesive layer on the film body 61 also to be effected in patterned form so that the process described here is combined with the process shown in FIG. 1.

The film body 61 and the adhesive layer 11v which is applied by printing thereto and which comprises an UV-crosslinkable adhesive are like the film body 51 and the adhesive layer 11s shown in FIG. 4, with the difference that here the adhesive layer 11v is preferably applied by printing to the film body 61 over the full area involved. The film 62 which is the result after application of the adhesive layer 11v to the film body 61 is fed to an exposure station 80.

The exposure station 80 is a mask exposure device 81m which permits exposure from roll to roll by means of a mask belt which is synchronised with the speed of movement of the film 62. The mask exposure device 81m has a plurality of deflection rollers 82, a mask belt 83m, an UV lamp 84 and a reflector 85. The mask belt 83m has UV-transparent and opaque or reflecting regions. The mask belt 83m thus forms an endless UV mask which covers over the film 62 with respect to the UV lamp 84 and permits continuous irradiation of the film 62 in pattern form with UV light. As already mentioned above the speed of the mask belt 83m is synchronised with the speed of the film 62, in which respect it can be provided that additional optical markings on the film 62 permit exposure in accurate register relationship. The power of the UV lamp 84 is so selected in this case that, on passing through the mask exposure device 81m, an amount of UV energy which is sufficient to harden the adhesive layer is applied to the film 62.

Preferably the film is irradiated by the mask exposure device 81m with collimated UV light.

Instead of an exposure station 80 with a mask exposure device it is also possible to use a drum exposure device 81t which has a mask in the form of a drum 83t over which the film 62 is guided as shown in the embodiment of FIG. 3.

Due to the irradiation with UV light in pattern form, the adhesive layer hardens structured in pattern form so that a film 63 with hardened and non-hardened regions of the adhesive layer is fed to the pair of rollers 31 and 32. The transfer film is now applied to the film 63 by the pair of rollers 31 and 32. In that case the transfer film is like the transfer film 41 shown in FIG. 5. That therefore involves a film 64 comprising the film body 61, a partially hardened adhesive layer 11b, the magnetic layer 44, the release layer 43 and the carrier film 42. In the regions in which the adhesive layer 11b has not hardened the adhesive layer 11p is still sticky so that here adhesion forces are operative between the adhesive layer 11p and the magnetic layer 44 disposed thereover. That is not the case in the other regions in which the adhesive layer 11p has hardened.

In a further exposure station which is of a configuration like the exposure station 20 shown in FIG. 1, the adhesive layer is now completely hardened in the regions which had not yet hardened in order to ensure a secure connection between the magnetic layer 44 and the film body 61. It would however also be possible to dispense with the exposure station 20.

Thus, when the carrier film 42 is pulled off the remaining film body, the magnetic layer 44 adheres to the film body 61 in the regions in which the adhesive layer has not hardened or the adhesive layer has hardened in the exposure station 20, and is thus detached from the carrier film 42. In the other regions the adhesion forces between the release layer 43 and the magnetic layer 44 provide that the magnetic layer 44 is not released in those regions and remains on the carrier film 42. Thus, after the carrier film 42 is removed, the result is a film 65 with a partial patterned magnetic layer 44 which is joined to the film body 61 by way of a full-area adhesive layer.

FIG. 8 shows the film 65, that is to say the resulting film body after removal of the carrier film 42. FIG. 8 shows the film body 61, the adhesive layer 11p whose regions which were hardened in the exposure station 80 are identified by hatching and the magnetic layer 44. As shown in FIG. 8 the film 65 now has a magnetic layer 44 which is structured in pattern form and which is arranged on the film body 61 in accordance with the adhesive layer 11p which is structured in pattern form.

A further embodiment which is shown in FIG. 4 involves using an UV-crosslinkable adhesive whose adhesion force in relation to the magnetic layer 44 or in relation to the film body 61 is less than the adhesion force between the magnetic layer 44 and the carrier film 42. It will be appreciated that it is also possible to use the same adhesive as shown in FIG. 2 or FIG. 3 and to provide for suitable distribution of the adhesion forces by virtue of the choice of the materials for the carrier film 42, the film body 61 or the release layer 43.

The film body 61 which is coated with an adhesive layer as in the embodiment shown in FIG. 2 is fed to the printing station 100, thereby producing the film 62 shown in FIG. 2. The transfer film 41 is now applied to the film 62 by the pair of rollers 31 and 32. In this case the transfer film 41 is of the configuration shown in FIG. 6. This therefore involves a film 66 comprising the film body 61, a full-area, non-hardened adhesive layer, the magnetic layer 44, the release layer 43 and the carrier film 42.

The film 66 is now exposed by means of the mask exposure device 81m which once again is of a design configuration like the mask exposure device 81m shown in FIG. 2. After exposure by means of the mask exposure device 81m therefore the result is a film 67 comprising the film body 61, an adhesive layer which is hardened structured in pattern form, the magnetic layer 44, the release layer 43 and the carrier film 42.

When then the carrier film 42 is pulled off the remaining film body of the film 67, the magnetic layer remains on the film body 61 in the regions in which the adhesive layer has hardened and thus the magnetic layer 44 is caused to adhere to the film body 61. In the other regions the adhesion forces which prevent detachment of the magnetic layer 44 from the carrier film 42 are greater than the adhesion forces between the magnetic layer 44 and the film body 61 so that the magnetic layer 44 is not released from the carrier film 42 in those regions. That therefore affords a film 68 having a magnetic layer 44 which is structured in pattern form and which is connected to the film body 61 by way of a hardened adhesive layer which is correspondingly structured in pattern form.

It can advantageously be provided that prepared security threads can be produced by dividing up the base film coated with the magnetic layer, as are provided for example for banknotes, credit cards, identity cards or passes or tickets.

What is claimed is:

1. A process for the production of a security element for value documents including banknotes, credit cards, identity cards, passes or tickets including a second film body with a partial magnetic coating,
comprising:
an adhesive layer of a radiation-crosslinkable adhesive is applied to a first film body the adhesive layer of the radiation-crosslinkable adhesive is hardened structured in pattern form by a procedure whereby the adhesive layer is at least one of
a) applied to the first film body in a form structured as a first pattern and is irradiated,
b) applied to the first film body in a form structured as a first pattern and is irradiated in a pattern form differently from the first pattern, and
c) is irradiated in pattern form and wherein
a transfer film which has a carrier film and a magnetic layer is applied to the adhesive layer with an orientation of the magnetic layer relative to the adhesive layer wherein in case a) the irradiation operation is effected after application of the transfer film to the adhesive layer, and in cases b) and c) the irradiation operation is effected prior to or after application of the transfer film to the adhesive layer, and the carrier film is removed from the second film body including the first film body, the adhesive layer and regions of the magnetic layer in the form of a partial magnetic coating, wherein the magnetic layer remains on the first film body in a first region structured in pattern form and in a second region structured in pattern form the magnetic layer remains on the carrier film and is removed with the carrier film from the first film body.

2. A process according to claim 1 wherein in case a) the adhesive layer of a radiation-crosslinkable adhesive is applied in pattern form to the first film body by means of a printing process, the transfer film is applied to the adhesive layer which is structured in pattern form, the adhesive layer is hardened by radiation and the carrier film is removed from the second film body including the first film body, the adhesive layer and regions of the magnetic layer so that the magnetic layer remains on the first film body in the first region coated in pattern form with the radiation-crosslinkable adhesive and is removed in the other second region with the carrier film.

3. A process according to claim 1 wherein in case b) or c) the adhesive layer of a radiation-crosslinkable adhesive is exposed in pattern form after application of the transfer film, whereby the adhesive layer hardens in a region which is structured in pattern form, and the carrier film is removed from the second film body including the first film body, the adhesive layer and regions of the magnetic layer so that the magnetic layer remains on the first film body in the first region which is structured in pattern form and in which the adhesive layer is hardened, and is removed with the carrier film in the second region in which the adhesive layer is not hardened, wherein the radiation-crosslinkable adhesive in the non-hardened condition has a lower adhesion force in relation to the magnetic layer than the adhesion force between the magnetic layer and the carrier film.

4. A process according to claim 1 wherein in case b) or c) the adhesive layer of a radiation-crosslinkable adhesive is irradiated in pattern form prior to application of the transfer film in such a way that the adhesive layer hardens in a region which is structured in pattern form, the transfer film is applied to the adhesive layer which is hardened structured in pattern form, and the carrier film is removed from the second film body including the first film body, the adhesive layer and the magnetic layer so that the magnetic layer remains on the first film body in the first region which is structured in pattern form and in which the adhesive layer is not hardened and is removed with the carrier film in the second region which is structured in pattern form and in which the adhesive layer is hardened.

5. A process according to claim 3 wherein the adhesive layer is then irradiated in a second exposure step for hardening of the regions which have not yet hardened of the adhesive layer.

6. A process according to claim 3 wherein a mask exposure device, is used for the exposure operation.

7. A process according to claim 1 wherein the magnetic layer is a layer of magnetic nanoparticles.

8. A process according to claim 7 wherein the layer of nanoparticles is applied as a deposit from a solution to the carrier film.

9. A process according to claim 7 wherein the magnetic layer is applied to the carrier film by sputtering.

10. A process according to claim 1 wherein the magnetic layer comprises amorphous metal glass.

11. A process according to claim 10 wherein the amorphous metal glass is formed from at least one of iron, cobalt, chromium, nickel, silicon and boron, and applied to the carrier film by sputtering.

12. A process according to claim 1 wherein the magnetic layer is semi-transparent, the carrier layer is radiation-transparent and the adhesive layer is exposed from the side of the transfer film (41) through the transfer film.

13. A process according to claim 1 wherein the first film body is radiation-transparent and the adhesive layer is exposed from the side of the first film body through the first film body.

14. A process according to claim 1 wherein a radiation-crosslinkable adhesive is used, which in the non-hardened condition has a lower adhesion force in relation to the magnetic layer than the adhesion force between the magnetic layer and the carrier film.

15. A process according to claim 1 wherein the adhesive layer comprises an electrically non-conductive adhesive.

16. A process according to claim 1 wherein the adhesive layer is applied to the first film body by means of intaglio printing.

17. A process according to claim 1 wherein the adhesive layer is applied to the first film body by means of offset printing or flexoprinting.

18. A process according to claim 1 wherein a transfer film is used which has a release layer between the carrier film and the magnetic layer.

19. A security element including at least one magnetic layer,
wherein
an adhesive layer including a radiation-crosslinkable adhesive and wherein the adhesive layer is arranged between a magnetic layer structured in pattern form and a first film body of the security element and connects the magnetic layer structured in pattern form to the first film body wherein at least one of the magnetic layer is semi-transparent and the first film body is radiation-transparent.

20. A security element according to claim 19 wherein the magnetic layer is formed from magnetic nanoparticles, preferably iron oxide.

21. A security element according to claim 19 wherein the magnetic layer is made from amorphous metal glass.

22. A security element according claim 19 wherein the first film body has a metal layer.

23. A security element according to claim 22 wherein the first film body is metallised with aluminium.

24. A security element according to claim 21 wherein a diffractive structure is shaped into the metal layer.

25. A security element according to claim 23 wherein the first film body is partially metallised with aluminium and the adhesive layer and the magnetic layer are applied to the partially metallised aluminium layer in register relationship with the regions partially metallised with aluminium.

26. A security element according to claim 19 wherein the adhesive layer of a radiation-crosslinkable adhesive is structured in pattern form in the same way as the magnetic layer which is structured in pattern form.

27. A security element according to claim 19 wherein the adhesive layer is in the form of adhesive which hardens under UV light.

28. A security element according to claim 19 wherein the adhesive layer is in the form of a non-conducting layer for preventing local element formation between the magnetic layer and the metal layer of the first film body.
